(19) United States
(12) Patent Application Publication
(10) Pub. No.: US 2017/0234515 A1
(43) Pub. Date: Aug. 17, 2017

(54) LUMINOUS PANEL

(71) Applicant: SAINT-GOBAIN PLACO, Suresnes (FR)

(72) Inventors: Pierre DALMAY, Jaignes (FR); Manuel CAPITAO DA COSTA, Le Raincy (FR); Yves BENKEMOUN, Villennes Sur Seine (FR)

(21) Appl. No.: 15/518,579

(22) PCT Filed: Oct. 12, 2015
(86) PCT No.: PCT/FR2015/052738

§ 371 Date: Apr. 12, 2017

(30) Foreign Application Priority Data
Oct. 13, 2014 (FR) 1459817

(51) Int. Cl. F21V 21/04; F21S 8/02

(52) U.S. Cl. CPC F21V 21/047; F21S 8/024; F21S 8/026

(57) ABSTRACT

A luminous panel includes a light-emitting board having a light-emitting face to form a surface of a wall device, and a receiving part to be fastened to a framing of the wall device. The light-emitting board is removably attachable to the receiving part. In the installed configuration, the emitting face forms a part of the surface of the wall device and the receiving part is at the rear of the surface of the wall device. The light-emitting board and the receiving part include complementary rotational members located near first ends of the light-emitting board and the receiving part, and complementary snap-fastening members located near second ends of the light-emitting board and the receiving part. In the assembled state, the receiving part is completely covered by the light-emitting board and the rotational members are housed in the volume between the light-emitting board and the receiving part.

The present invention relates to a luminous panel intended to be installed in a wall device, in particular a partition or a ceiling. The invention also relates to a wall device comprising such a luminous panel.

Within the context of the invention, the expression “wall device” is understood to mean a device comprising both facing elements forming the surface of the wall and a framing supporting these facing elements. By way of example, it may be a wall partition comprising plasterboards positioned in a partition framing composed of bottom and top runners (or wall rails) and studs. As a variant, it may be a ceiling comprising ceiling tiles positioned in a ceiling framing.

It is known to integrate a light-emitting board into a building partition, where the light-emitting board comprises a rigid support provided on at least one face with a light-emitting covering, such as a light-emitting fabric or an organic light-emitting diode (OLED) device. Advantageously, the support used to form the light-emitting board is a structural element of a building wall, such as a wall facing or a ceiling tile. It is then possible, by positioning several light-emitting boards in a conventional partition or ceiling framing system, to obtain a luminous wall that may play a double role as a wall and as a luminaire.

WO 2010/058096 A1 describes a luminous partition in which a light-emitting board, comprising a rigid support, a front face of which is covered with a light-emitting fabric, is mounted between a bottom runner and a top runner connected to a bearing structure supporting the partition. The light-emitting board is supported in the bottom part by feet, where each foot comprises a threaded rod which is fastened, by means of a nut, to a casing firmly attached to the rear face of the support. In this device, the feet rest inside the bottom runner of the partition.

Fitting a luminous partition as described in WO 2010/058096 A1 involves specific assembly steps for the positioning of the light-emitting board and its support feet, which do not have to be carried out during the installation of conventional partitions. This makes it necessary to train the installers especially in the fitting of such luminous partitions. Furthermore, the assembly and the disassembly of the light-emitting board with respect to the framing of the luminous partition, in particular for the purposes of maintenance or upkeep of the components that are inside the partition, cannot be carried out easily by an end user and require specialists to be brought in.

It is these drawbacks that the invention intends more particularly to solve by proposing a luminous panel that enables easy assembly and disassembly of a light-emitting board with respect to a wall device, without the need for particular training or tools, so that the maintenance of the luminous panel once integrated into a wall device can be carried out easily, and in particular by an end user, this light panel moreover guaranteeing a good visual appearance of the wall, both when the light-emitting board is switched off and switched on.

For this purpose, one subject of the invention is a luminous panel intended to be installed in a wall device, in particular a partition or a ceiling, comprising a light-emitting board, one light-emitting face of which is intended to form at least one part of the surface of the wall, and a light-emitting board receiving part, which is intended to be fastened to a framing of the wall, wherein the light-emitting board is capable of being attached removably to the receiving part so that, in the installed configuration, the emitting face forms a part of the surface of the wall and the receiving part is at the rear of the surface of the wall, the light-emitting board and the receiving part comprising complementary rotational members, which are located in the vicinity of first ends of the light-emitting board and of the receiving part, and complementary snap-fastening members, which are located in the vicinity of second ends of the light-emitting board and of the receiving part, wherein, in the assembled state of the light-emitting board and of the receiving part, the receiving part is completely covered by the light-emitting board and the rotational members are housed in a volume defined between the light-emitting board and the receiving part.

Within the context of the invention, the terms “front” and “rear” are used to define a position relative to the surface of the wall, where the surface of the wall is one face of the wall which delimits a room. Within the meaning of the invention, an element is arranged at the front of the surface of the wall when it is included in the half-space which faces, or which is opposite, the surface of the wall, whereas an element is arranged at the rear of the surface of the wall when it is included in the other half-space.

The invention proposes a two-part luminous panel, comprising a removable part, which is the light-emitting board, and a fixed part, which is a light-emitting board receiving part firmly attached with a framing of the wall device. The removable light-emitting board is housed in the fixed receiving part according to an “access hatch” type system, comprising rotational members at one end of the luminous panel and snap-fastening members at an opposite end of the luminous panel.

Advantageously, the luminous panel can be integrated esthetically in the wall device because, in the assembled state of the light-emitting board and of the receiving part, the fastening means between the light-emitting board and the receiving part, which are the rotational members and the snap-fastening members, are not visible at the surface of the wall and are housed in the volume defined between the light-emitting board and the receiving part.

The installation of a luminous panel according to the invention is carried out in a manner similar to an access hatch, which does not require particular training for the installers. Advantageously, the light-emitting board, which is a fragile part since it comprises the light-emitting elements and the electrical device, may be removed during the fitting of the receiving part, until the end of the finishing works which are the jointing or painting. It is thus possible to carry out the structural work without risking deteriorating the fragile part of the luminous panel comprising the light-emitting elements and the electrical device. Once the structural work is complete, the light-emitting board is easily put back into place in the receiving part, by engagement of the rotational members and activation of the snap-fastening members.

Furthermore, owing to the invention, the light-emitting board may be easily assembled and disassembled with respect to the wall device, including by an end user. For the disassembly of the light-emitting board, the user acts directly on the second end of the light-emitting board, so as to deactivate the snap-fastening members, then disengages the rotational members of the light-emitting board and of the receiving part. Here too, for the reassembly, the light-emitting board is easily put back into place in the receiving part, by engagement of the rotational members and activation of the snap-fastening members. Advantageously, these operations for fitting and removing the light-emitting board are carried out by hand, without requiring tooling. The user may thus easily have access to the rear of the light-emitting board, for example in order to carry out maintenance of the electrical device. He may also easily set the light-emitting board aside, for example if he wishes to repaint the wall without risking deteriorating the light-emitting elements or the electrical device.

Advantageously, the luminous panel, in the assembled state of the light-emitting board and of the receiving part, has a thickness less than or equal to the thickness of the wall device, taken transversely to the surface of the wall device. The luminous panel is thus capable of being installed in the wall device by being completely housed within the thickness of the wall device, in particular within the thickness of the framing of the wall device.

According to one feature, the rotational members comprise an axle, borne by one from among the light-emitting board and the receiving part, and a guiding element, borne by the other from among the light-emitting board and the receiving part. By way of example, the axle and the guiding element may be two sections, one borne by the light-emitting board and the other by the receiving part, which are provided in order to slidingly bear against one another, the section of the receiving part forming a guiding element whereas the section of the light-emitting board forms a pivot axle. As a variant, the axle may be an axle with circular cross section borne by one from among the light-emitting board and the receiving part, which is intended to cooperate with a flared housing formed on the other from among the light-emitting board and the receiving part.

In practice, the function of the complementary rotational members is not only to enable a pivoting of the light-emitting board with respect to the receiving part, but also to ensure a precise positioning of the light-emitting board with respect to the receiving part, so as to enable the engagement of the snap-fastening members when the rotational members are engaged with one another.

When the luminous panel is intended to be installed in a substantially vertical wall device, the first ends of the light-emitting board and of the receiving part, which comprise the rotational members, are preferably positioned towards the bottom, whereas the second ends of the light-emitting board and of the receiving part, which comprise the snap-fastening members, are positioned towards the top. Thus, the rotational members, in particular in the form of sections extending along the width of the light-emitting board, help to support the weight of the light-emitting board.

According to one aspect of the invention, when the rotational members are engaged with one another, the snap-fastening members are capable of being activated or deactivated by the application of a thrust force of the second end of the light-emitting board in the direction of the second end of the receiving part. Advantageously, the snap-fastening members are in the form of at least one mechanical latch, one part of which is borne by the light-emitting board and the other part by the receiving part, in particular a latch of “push-release” type.

According to one feature, the rotational members, when they are engaged with one another, are suitable for enabling a pivoting of the light-emitting board with respect to the receiving part between a closed position, in which the second end of the light-emitting board is opposite the second end of the receiving part and the snap-fastening members are activated, and an open position, in which the light-emitting board is inclined at an angle with respect to the receiving part with the second end of the light-emitting board at a distance from the second end of the receiving part and the snap-fastening members are deactivated.

Preferably, the luminous panel comprises means for holding the light-emitting board with respect to the receiving part in the open position. These holding means, which may for example be in the form of a safety chain fixed between the light-emitting board and the receiving part, make it possible to prevent any dropping of the light-emitting board when the snap-fastening members have been deactivated. This facilitates and makes safe the operations for fitting and removing the light-emitting board.

According to one feature, in the installed configuration of the luminous panel in a wall device, the emitting face of the light-emitting board is flush with the rest of the surface of the wall. The integration of the luminous panel into the wall device may thus be carried out flush, without requiring the fitting of a metal frame around the light-emitting board. It is thus possible to obtain a uniform visual appearance of the surface of the wall, in particular when the light-emitting board is switched off. Within the meaning of the invention, an element is flush with the surface of the wall when it has an overthickness, with respect to this surface, of less than or equal to 2 mm, preferably less than or equal to 1 mm, more preferably less than or equal to 0.5 mm and more preferably still zero.

According to one aspect of the invention, in the assembled state of the light-emitting board and of the receiving part, the receiving part is completely covered by the light-emitting board. Thus, when the luminous panel is installed in a wall device, only the emitting face of the light-emitting board is visible at the surface of the wall.

Advantageously, the light-emitting board and the receiving part comprise complementary magnetic elements positioned along side edges connecting the first ends and second ends of each of the light-emitting board and the receiving part. These magnetic elements help to hold the light-emitting board on the receiving part.

According to one aspect of the invention, the luminous panel comprises a device for powering the light-emitting board, which is housed in the volume defined between the light-emitting board and the receiving part.

Preferably, the receiving part comprises a base opposite the light-emitting board. Thus, fragile elements of the light-emitting board, such as light sources or electrical or electronic components, are housed in the volume defined between the light-emitting board and the base of the receiving part.

According to one aspect of the invention, the light-emitting board comprises a support, preferably a rigid or semi-rigid support, at least one face of which is provided with a covering suitable for emitting light. Preferably, the support is a wall facing, in particular a plasterboard, or a ceiling tile, in particular a tile based on fibres, in particular compressed mineral fibres. The covering suitable for emitting light may be of any type capable of being combined with a support. It may be, in particular, a light-emitting fabric formed by weaving optical fibres, which covers a front face of the support, where the ends of the optical fibres are folded around the edges of the support and fastened on the rear face of the support. As a variant, the covering suitable for emitting light may be a flexible or rigid surface light guide, for example a scattering plate made of glass or made of polymethyl methacrylate (PMMA) edge-lit using light-emitting diodes (LEDs). According to another variant, the covering suitable for emitting light may be any type of surface source, in particular a rigid or flexible OLED device.

Another subject of the invention is a wall device, in particular a partition or a ceiling, comprising a luminous panel as described above. The receiving part is rigidly fixed to a framing of the wall device, whereas the light-emitting board is inserted between facing elements of the wall device. Preferably, the wall device comprises finishing joints at each joint between the light-emitting board and an adjacent facing element.

In the case of a vertical wall device comprising a framing, in particular vertical studs, and a plurality of facing boards, in particular plasterboards or wooden boards, positioned in the framing so as to form at least one wall, the receiving part of the luminous panel is advantageously fixed to the vertical studs of the framing, for example by screwing. Such a vertical wall device may be, for example, a demountable wall partition with two walls capable of defining two spaces, or a covering wall of a building wall.

The features and advantages of the invention will appear in the following description of an embodiment of a luminous panel according to the invention, given solely by way of example and with reference to the appended drawings, in which:

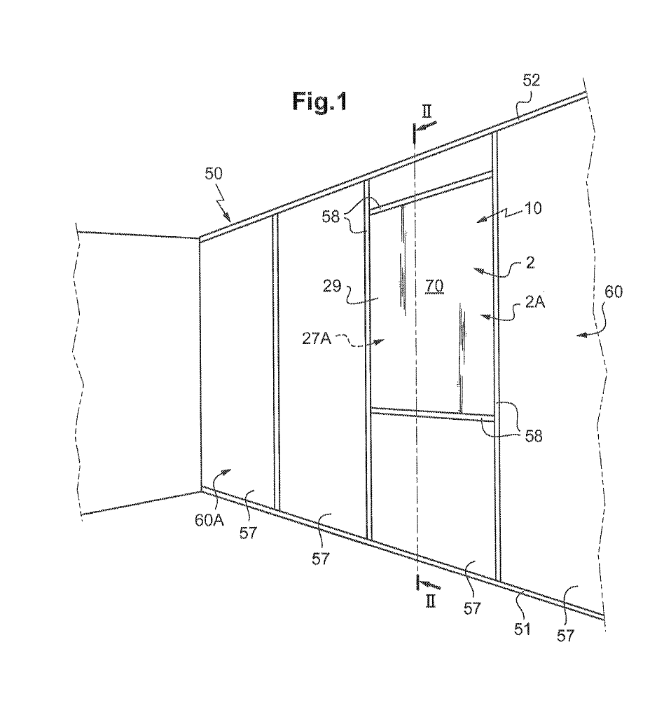

FIG. 1 is a front view in partial perspective of a building wall partition comprising a luminous panel in accordance with the invention;

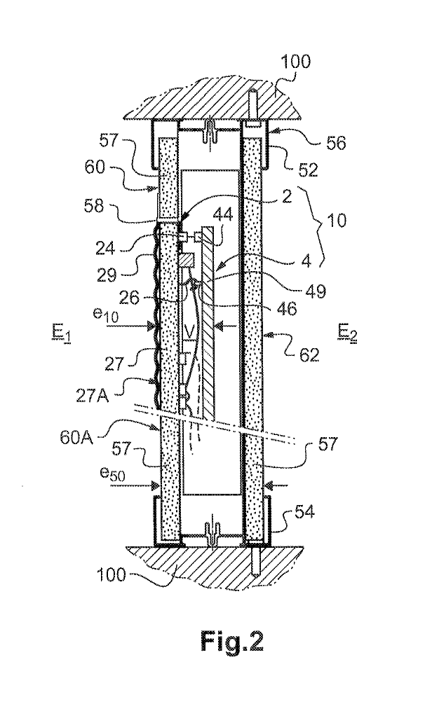

FIG. 2 is a schematic cross section along the line II-II from FIG. 1;

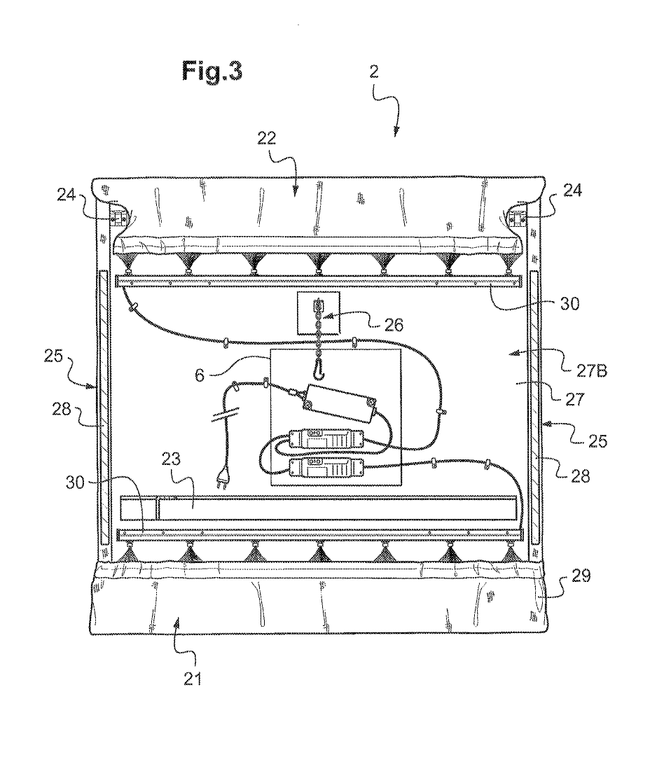

FIG. 3 is a rear view of the light-emitting board of the luminous panel from FIG. 1;

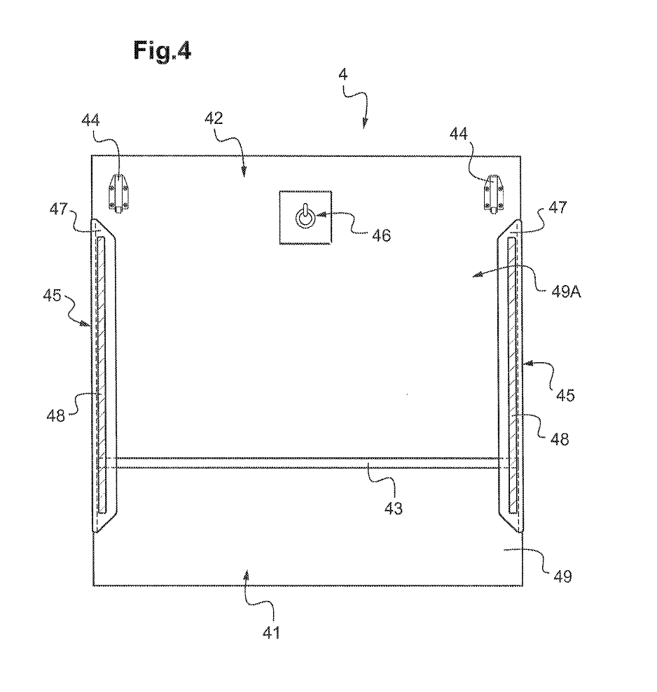

FIG. 4 is a front view of the receiving part of the luminous panel from FIG. 1;

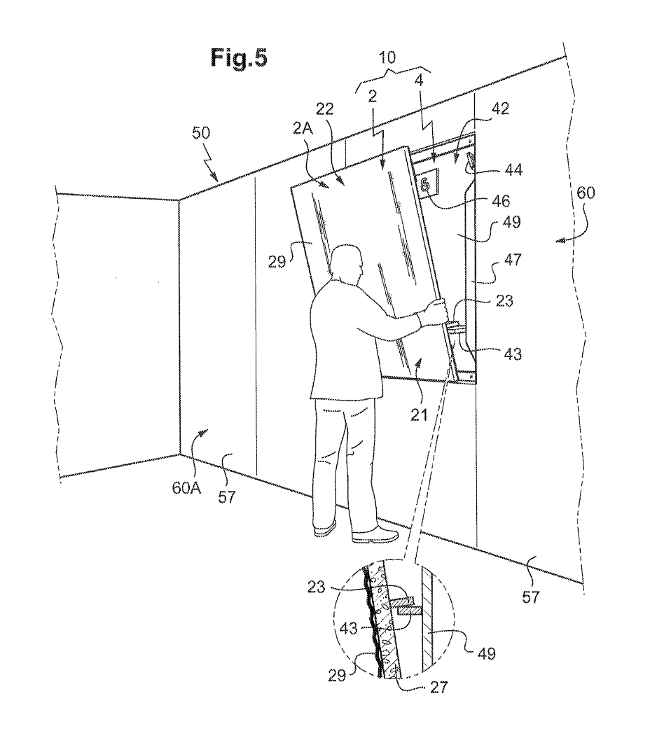

FIG. 5 is a view similar to FIG. 1, showing a first step of assembling the light-emitting board with respect to the receiving part of the luminous panel which has been previously attached to the framing of the partition;

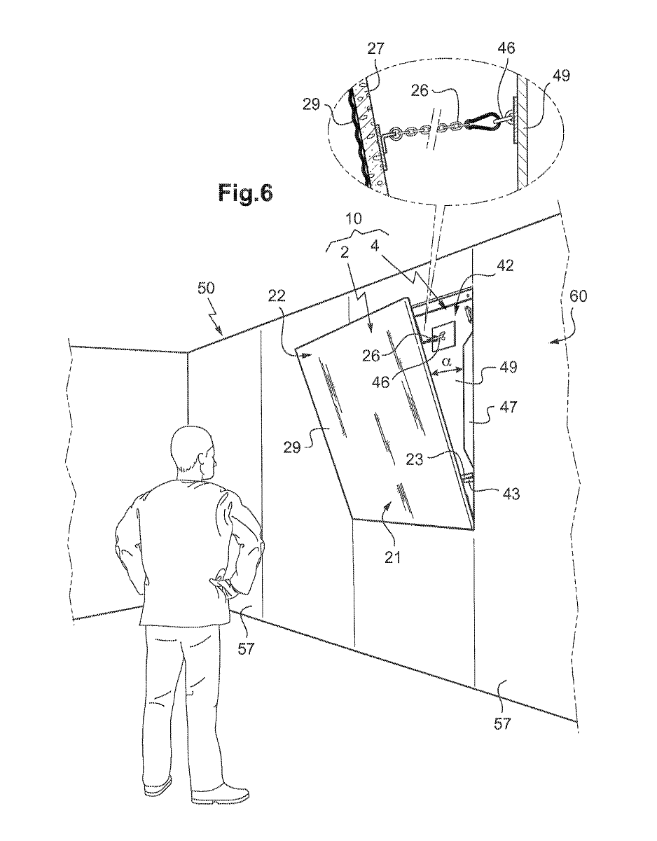

FIG. 6 is a view similar to FIG. 1, showing a second step of assembling the light-emitting board with respect to the receiving part of the luminous panel; and

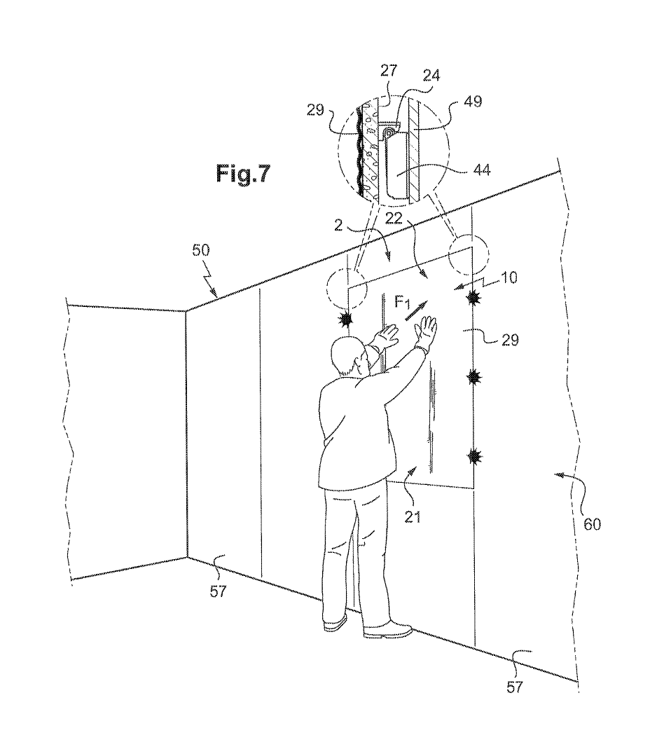

FIG. 7 is a view similar to FIG. 1, showing a third step of assembling the light-emitting board with respect to the receiving part of the luminous panel.

FIGS. 1 and 2 show a wall partition 50, of dismantlable partition type, comprising a luminous panel 10 according to the invention. Conventionally, the partition 50 comprises a framing 56, which is formed by a bottom runner 51 and a top runner 52 connected to a bearing structure 100 supporting the partition, and by vertical studs, not represented, which extend between the top and bottom runners. The partition 50 also comprises a plurality of facing boards 57, which are for example plaster boards such as those known under the name BA13. The facing boards 57 are positioned in the framing 56 of the partition so as to form two walls 60 and 62 that extend substantially parallel to one another and which act as walls for, respectively, a space E1 and a space E2 that are delimited by the partition, as can be seen in FIG. 2.

In this embodiment, the wall 60 of the partition 50 comprises a facing board 57 which is pierced in its upper part by an opening 70 suitable for receiving the luminous panel 10 according to the invention. In accordance with the invention, the luminous panel 10 comprises two main parts capable of being assembled in a removable manner, namely a light-emitting board 2 and a receiving part 4. The light-emitting board 2 is powered by any means known to a person skilled in the art, and can be controlled by means of one or more switches so as to regulate the luminosity in the space E1. Thus, owing to the light panel 10, the partition 50 plays, for the space E1, a double role as a wall and as a luminaire.

As is clearly visible in FIG. 3, the light-emitting board 2 comprises a support 27, which is for example a facing board of the same type as the boards 57, that is to say a plaster board of BA13 type. The facing board 27 is covered on a front face 27A with a light-emitting fabric 29, formed by weaving optical fibres. The light-emitting fabric 29 thus forms a light-emitting face 2A of the light-emitting board 2. The optical fibres may be weft yarns and/or warp yarns of the light-emitting fabric 29. The optical fibres go beyond the surface of the light-emitting fabric 29 in order to be connected to light sources, which are for example light-emitting diodes (LEDs).

More specifically, in this embodiment, the optical fibres are folded around the bottom and top ends of the facing board 27 and connected to the light sources that are found against the rear face 27B of the board 27. The light sources are positioned, in the vicinity of the bottom end 21 and of the top end 22 of the light-emitting board 2, in two casings 30 firmly attached, in particular by bonding, to the rear face 27B of the board 27. The optical fibres of the light-emitting fabric 29 are thus supplied with light both from the top and from the bottom. This makes it possible to have a substantially uniform distribution of the light over the entire surface of the light-emitting fabric 29, by eliminating the attenuations that could appear at the ends of the optical fibres far away from the light sources.

Each casing 30 is electrically connected to an electrical power device 6, which is also firmly attached, in particular by bonding, to the rear face 27B of the board 27, in a central zone thereof. The electric power device 6 comprises in particular a transformer, powered by a cable that may advantageously circulate in the bottom runner 51 of the partition 50.

The light-emitting board 2 is provided in order to be attached removably to the receiving part 4 so that, in the installed configuration, the emitting face 2A of the light-emitting board 2 forms a part of the surface 60A of the wall 60, whereas the receiving part 4 is at the rear of the surface 60A. As shown in FIG. 2, in the assembled state of the light-emitting board 2 and of the receiving part 4, the luminous panel 10 has a thickness e₁₀ less than or equal to the thickness e₅₀ of the partition 50, taken transversely to the surface 60A. Advantageously, in the assembled state of the light-emitting board 2 and of the receiving part 4, the receiving part 4 is completely covered by the light-emitting board 2. Thus, when the luminous panel 10 is installed in the partition 50, only the emitting face 2A of the light-emitting board is visible at the surface of the wall 60, which guarantees a good visual appearance.

As shown in FIG. 4, the receiving part 4 is formed by a metal component comprising a base 49 and two side wings 47. The receiving part 4 is provided in order to be rigidly fixed to the framing 56 of the partition 50, in particular by screwing onto the studs of the framing in the vicinity of the wings 47. In the assembled state of the light-emitting board 2 and of the receiving part 4, a front face 49A of the base 49 is opposite the rear face 27B of the facing board 27. A volume V is thus defined between the light-emitting board 2 and the receiving part 4, in which the casings 30 of the light sources and the electric power device 6 are housed.

For the reversible assembly thereof, the light-emitting board 2 and the receiving part 4 comprise complementary rotational members and complementary snap-fastening members.

In this embodiment, the rotational members are, respectively, a section 23 borne by the light-emitting board 2 in the vicinity of its bottom end 21, and a section 43 borne by the receiving part 4 in the vicinity of its bottom end 41. In the assembled state of the light-emitting board 2 and of the receiving part 4, the receiving part is completely covered by the light-emitting board and the rotational sections 23 and 43 are housed in the volume V defined between the light-emitting board 2 and the receiving part 4. The sections 23 and 43 are provided in order to slidingly bear against one another, the section 43 forming a guiding element whereas the section 23 forms a pivot axle. Preferably, the sections 23 and 43 extend over the entire width of the light-emitting board 2 and of the receiving part 4, transversely to the side edges 25 and 45 thereof. The section 43 of the receiving part 4 is configured to ensure a rigid holding of the light-emitting board 2 and to support its weight.

The snap-fastening members are themselves formed by two mechanical latches of “push-release” type located at the two top corners of the luminous panel 10. For each latch, a first part 24 of the latch is borne by the light-emitting board 2, in the vicinity of a corner of the top end 22 of the light-emitting board, whereas a second part 44 of the latch complementary to the first part is borne by the receiving part 4, in the vicinity of a corner of the top end 42 of the receiving part. The positioning of the latches is adjusted so that, when the sections 23 and 43 bear against one another as can be seen in the detail from FIG. 5, the first parts 24 and the second parts 44 of the latches are capable of being engaged with one another by the application of a thrust force F₁ of the top end 22 of the light-emitting board 2 in the direction of the top end 42 of the receiving part 4, as shown by the arrow F₁ from FIG. 7.

The sections 23 and 43, when they bear against one another as can be seen in the detail from FIG. 5, are suitable for enabling a pivoting of the light-emitting board 2 with respect to the receiving part 4 between a closed position, seen in FIGS. 1, 2 and 7, in which the top end 22 of the light-emitting board is opposite the top end 42 of the receiving part and the first parts 24 and second parts 44 of the latches are engaged with one another, and an open position, seen in FIGS. 5 and 6, in which the light-emitting board 2 is inclined with respect to the receiving part 4, with the top end 22 of the light-emitting board at a distance from the top end 42 of the receiving part and the first parts 24 and second parts 44 of the latches are separated.

In order to prevent any dropping of the light-emitting board 2 when the latches are deactivated, a chain 26 for holding the light-emitting board 2 in its open position is advantageously provided, which cooperates with a complementary ring 46 arranged on the base 49 of the receiving part. The security chain 26 may in particular allow an angle α of inclination of the light-emitting board 2 with respect to the receiving part 4 of the order of 10° to 30°, preferably of the order of 15°, which facilitates the operations for fitting and removing the light-emitting board 2.

Advantageously, in this embodiment, the light-emitting board 2 and the receiving part 4 also comprise magnetic strips 28 and 48, positioned along their side edges 25 and 45, which helps to hold the light-emitting board 2 on the receiving part 4.

As illustrated in FIGS. 5 to 7, the assembly of the luminous panel 10 in the partition 50 comprises a first step in which the receiving part 4 is rigidly fastened to the framing 56 of the partition, in particular by screwing. The light-emitting board 2 is then added to the receiving part 4, by engaging the sections 23 and 43 as shown in FIG. 5, and the security chain 26 is firmly attached to the ring 46 so as to fasten the light-emitting board 2 to the receiving part 4 in the open position. From this open position, seen in FIG. 6, in which the light-emitting board 2 is inclined at an angle α of the order of 10° to 30°, preferably of the order of 15°, with respect to the receiving part 4, a thrust force F₁ of the top end 22 of the light-emitting board 2 is applied in the direction of the top end 42 of the receiving part 4, as shown in FIG. 7. This enables the activation both of the latches, the parts 24 and 44 of which engage with one one another, and of the magnetic strips 28 and 48.

In order to ensure an optimal esthetic appearance of the wall 60, the partition 50 advantageously comprises finishing joints 58 at each join between the light-emitting board 2 and an adjacent facing board 57. Advantageously, these finishing joints may be produced using sections of Placolistel® type sold by Placoplatre, which are inserted in each join between the light-emitting board 2 and an adjacent facing board 57, fastened by screwing into the facing board 57, then covered with a finishing coat.

Preferably, the light-emitting board 2 is removed during the finishing works, which are jointing or else painting, which makes it possible to prevent any deterioration of the light-emitting board. The light-emitting board 2 may also be easily disassembled, by applying, on the top end 22 of the light-emitting board, a new thrust force in the direction of the arrow F₁ from FIG. 7, so as to separate the parts 24 and 44 of the latches, then by detaching the chain 26 relative to the ring 46 and by disengaging the section 23 relative to the section 43. Once the finishing works are complete, the light-emitting board 2 may easily be put back into place in the receiving part 4, by engagement of the sections 23 and 43 and activation of the magnetic strips 28 and 48 and of the parts 24 and 44 of the latches, making sure to reattach the chain 26 to the ring 46.

As it emerges from the preceding embodiment, the assembly and disassembly of the light-emitting board 2 with respect to the receiving part 4 are carried out particularly easily, without requiring tooling. A user may thus easily access the rear of the light-emitting board 2, for example to carry out the maintenance of the electrical device 6. Furthermore, the luminous panel 10 according to the invention makes it possible to obtain a luminous surface of large size in a partition wall, with a good visual appearance, insofar as the fastening means between the light-emitting board 2 and the receiving part 4 are housed in the volume V at the rear of the surface of the wall and thus not visible. A good visual appearance is also ensured at the join between the light-emitting board and each adjacent facing board, where finishing joints are advantageously made. Very advantageously, the luminous panel 10 in accordance with the invention can be easily integrated into a conventional framing system of a wall device, such as a wall partition or a covering wall, which makes it possible to easily form a wall that provides a double function as a wall and as a luminaire.

The invention is not limited to the embodiment described and represented.

In particular, the invention has been illustrated in the case of a luminous panel which is added to an opening pierced in a facing board of a partition. The luminous panel may however occupy the entire height of the partition, by taking the place of a facing.

Furthermore, the invention has been illustrated in the case of a partition framing of dismantlable type. However, the invention also applies to other types of framings, in particular a framing of a covering wall of a building wall or a framing of a ceiling. In particular, when a luminous panel according to the invention is used in the case of a ceiling, the receiving part generally is fastened to a framing produced underneath a floor.

The support of the light-emitting board of a luminous panel in accordance with the invention may also be different from a facing plasterboard. Any support capable of being integrated into the production of a building wall can be used within the context of the invention, which includes, by way of non-limiting examples, tiles made of mineral wool, melamine-faced panels, laminated panels, boards made of natural wood, metal sheets.

The light-emitting covering of the light-emitting board of a luminous panel in accordance with the invention may also be different from a light-emitting fabric resulting from the weaving of optical fibres. It may be, as a variant, any flexible or rigid surface light guide, for example a scattering plate edge-lit with the aid of light-emitting diodes (LEDs), or else any type of surface light source, for example an OLED device.

Finally, it is clearly understood that the complementary rotational and snap-fastening members described previously may be replaced by any other suitable members, as long as they provide a removable fastening of the light-emitting board to the receiving part.

1. A luminous panel to be installed in a wall device, comprising:
a light-emitting board having a light-emitting face that is intended to form at least one part of a surface of the wall device, and
a light-emitting board receiving part, which is intended to be fastened to a framing of the wall device,
wherein the light-emitting board is configured to be attached removably to the light-emitting board receiving part so that, in an installed configuration, the light-emitting face forms a part of the surface of the wall device and the light-emitting board receiving part is at a rear of the surface of the wall device, the light-emitting board and the light-emitting board receiving part comprising complementary rotational members, which are located in a vicinity of a first end of the light-emitting board and of a first end of the light-emitting board receiving part, and complementary snap-fastening members, which are located in a vicinity of a second end of the light-emitting board and of a second end of the light-emitting board receiving part, wherein, in an assembled state of the light-emitting board and of the light-emitting board receiving part, the light-emitting board receiving part is completely covered by the light-emitting board and the rotational members are housed in a volume defined between the light-emitting board and the light-emitting board receiving part.

2. The luminous panel according to claim 1, wherein the luminous panel, in the assembled state of the light-emitting board and of the light-emitting board receiving part, has a thickness less than or equal to a thickness of the wall device, taken transversely to the surface of the wall device.

3. The luminous panel according to claim 1, wherein the rotational members comprise an axle, borne by one from among the light-emitting board and the light-emitting board receiving part and a guiding element, borne by the other from among the light-emitting board and the light-emitting board receiving part.

4. The luminous panel according to claim 1, wherein, when the rotational members are engaged with one another, the snap-fastening members are capable of being activated or deactivated by an application of a thrust force of the second end of the light-emitting board in a direction of the second end of the light-emitting board receiving part.

5. The luminous panel according to claim 1, wherein the rotational members, when the rotational members are engaged with one another, enable a pivoting of the light-emitting board with respect to the light-emitting board receiving part between a closed position, in which the second end of the light-emitting board is opposite the second end of the light-emitting board receiving part and the snap-fastening members are activated, and an open position, in which the light-emitting board is inclined at an angle (α) with respect to the light-emitting board receiving part with the second end of the light-emitting board at a distance from the second end of the light-emitting board receiving part and the snap-fastening members are deactivated.

6. The luminous panel according to claim 5, comprising means for holding the light-emitting board with respect to the receiving part in the open position.

7. The luminous panel according to claim 1, wherein, in the installed configuration, the emitting face of the light-emitting board is flush with the rest of the surface of the wall device.

8. The luminous panel according to claim 1, wherein the light-emitting board and the light-emitting board receiving part comprise complementary magnetic elements along side edges connecting the first ends and second ends of each of the light-emitting board and the light-emitting board receiving part.

9. The luminous panel according to claim 1, comprising a device for powering the light-emitting board, which is housed in the volume defined between the light-emitting board and the light-emitting board receiving part.

10. The luminous panel according to claim 1, wherein the light-emitting board receiving part comprises a base opposite the light-emitting board.

11. The luminous panel according to claim 1, wherein the light-emitting board comprises a support, at least one face of which is provided with a covering adapted to emit light.

12. The luminous panel according to claim 11, wherein the support is a wall facing or a ceiling tile.

13. The luminous panel according to claim 11, wherein the covering adapted to emit light is a light-emitting fabric comprising optical fibres, covering a front face of the support, the wherein ends of the fibres are folded around ends of the support and connected to light sources on a rear face of the support.

14. A wall device comprising a luminous panel according to claim 1.

15. The wall device according to claim 14, wherein the wall device is a partition or a ceiling.
